(19) United States
(12) Patent Application Publication
(10) Pub. No.: US 2008/0191827 A1
(43) Pub. Date: Aug. 14, 2008

(54) Eye module

(75) Inventors: Lin Hsiao, Taoyuan County (TW); Wai William Wang, Taoyuan County (TW); Fung-Hsu Wu, Taoyuan County (TW); Chen Peng, Taipei (TW); Chung-Cheng Chou, Taoyuan (TW); Bow-Yi Jang, Taichung (TW); Ta-Yuan Lee, Taipei (TW)

Correspondence Address: BACON & THOMAS, PLLC, 625 SLATERS LANE, FOURTH FLOOR, ALEXANDRIA, VA, 22314, US

(73) Assignee: Qisda Corporation, Taoyuan Shien (TW)

(21) Appl. No.: 12/068,475

(22) Filed: Feb. 7, 2008

(30) Foreign Application Priority Data
Feb. 9, 2007 (TW) 96104893

(51) Int. Cl. H01F 7/122; H01F 7/18

(52) U.S. Cl. 335/268; 335/229

(57) ABSTRACT

An eye module at least including a body, a magnetic element, a casing and a plurality of magnet windings is provided. The body is a globe. The magnetic element is disposed on the body. The body is disposed in the casing in a rotatable manner. A plurality of magnet windings are disposed at the back of the body. The body is rotated by driving the magnet windings to function on the magnetic element.

This application claims the benefit of Taiwan application Serial No. 96104893, filed Feb. 9, 2007, the subject matter of which is incorporated herein by reference.

### BACKGROUND OF THE INVENTION

1. Field of the Invention

The invention relates in general to an eye module, and more particularly to an eye module which drives the body to rotate by a plurality of magnet windings incorporated with a magnetic element.

2. Description of the Related Art

With the advance in technology, various electronic products are presented and renewed. Especially, the presentation of robot and robotic pet has marked a milestone in the field of automation and artificial intelligence (AI). Of a robot or a robotic pet, the eye module is essential in showing moods.

According to the design of the eye module, the rotation of the eye module presents various moods and expressions of the robotic pet and robot. Conventional eye module is rotated by driving a servo motor to drive a gear mechanism to rotate the eye module. However, the eye module still has many bottlenecks to break through.

First, the size is too larger. The gear mechanism is formed by elements such as gears, chains and rods. As there are a lager number of elements, if the gears are too small, the teeth of the gear may be skipped or jammed. When the gear mechanisms are incorporated together, the size of the machine would be too large.

Secondly, the response rate is too slow. The eye module has to push the gear, the chain or the rod in order to finish a rotation, so the response rate is too slow.

Thirdly, the change is rigid. The change of the eye module is produced by the gear mechanism and is limited by the pitch and position of the gear. When the gear mechanism rotates a gear pitch, the eye module can only rotate to a certain extent rigidly. The eye module can only rotate according to the direction and position of the gear mechanism, so the rotation of the eye module is very rigid.

### SUMMARY OF THE INVENTION

The invention is directed to an eye module which drives the body to rotate by a force generated by driving a plurality of magnet windings to function on a magnetic element. The eye module of the invention not only enables the eye to rotate but also has the advantages of small size, light weight, fast and prompt response, all-directional rotation, accommodation of more elements, precise feedback control and interactive mode.

According to a first aspect of the present invention, an eye module at least including a body, a magnetic element, a casing and a plurality of magnet windings is provided. The body is a globe. The magnetic element is disposed on the body. The body is disposed in the casing in a rotatable manner. A plurality of magnet windings are disposed at the back of the body. The body is rotated by driving the magnet windings to function on the magnetic element.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of an eye module according to a first embodiment of the invention;

FIG. 2 is a perspective of the magnet winding and the fixing base of FIG. 1;

FIG. 3 is a perspective of the body of FIG. 1 rotating downward;

FIG. 4 is a perspective of the body of FIG. 1 rotating upward;

FIG. 5 is a perspective of a join force when three magnet windings are functioning at the same time;

FIG. 6 is a block diagram of the eye module of FIG. 1;

FIG. 7 is a perspective of the eye module of FIG. 1 following an article;

FIG. 8 is a perspective of the eye module of FIG. 1 using a feedback;

FIG. 9 is a perspective of the magnet winding and the fixing element of an eye module according to a second embodiment of the invention;

FIG. 10 is a perspective of the magnet winding and the fixing element of an eye module according to a third embodiment of the invention; and

FIG. 11 is a perspective of a magnet winding according to a fourth embodiment of the invention.

### DETAILED DESCRIPTION OF THE INVENTION

### First Embodiment

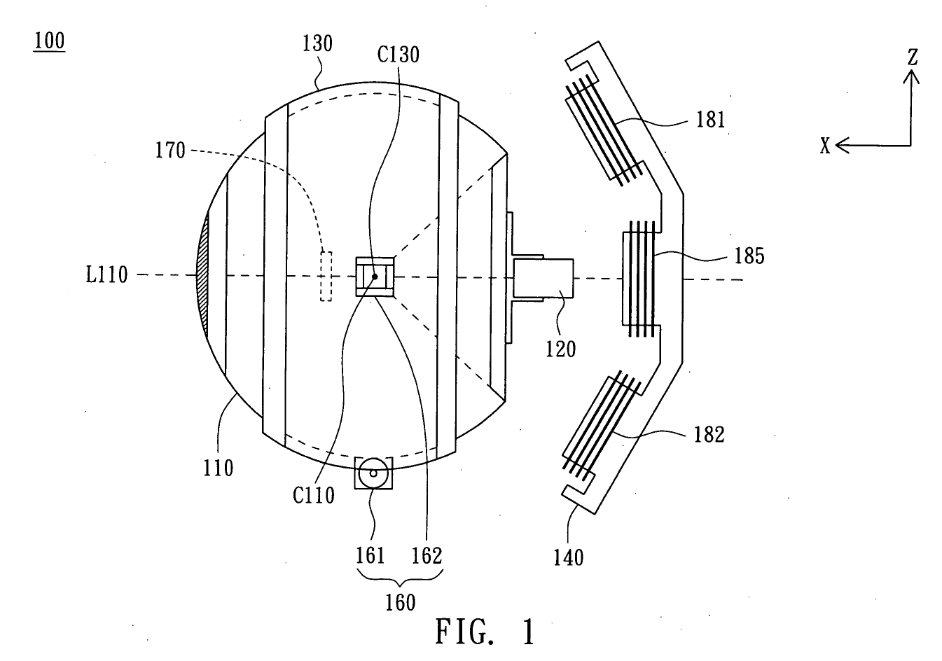

Referring to FIG. 1, a perspective of the eye module 100 according to a first embodiment of the invention is shown. The eye module 100 at least includes a body 110, a magnetic element 120, a casing 130, a plurality of magnet windings (FIG. 1 only illustrates magnet windings 181, 182, and 185). The body 110 is a globe. The magnetic element 120 is disposed on the body 110. The casing 130 is for receiving a part of the body 110 for allowing the body 110 to rotate in the casing 130. A plurality of magnet windings are disposed at the back of the body 110. At least a magnet winding functions on the magnetic element 120 to drive the body 110 to rotate.

Each magnet winding is formed by winding a wire in a direction and generates a magnetic force when the magnetic winding is turned on, wherein the surface of the wire is isolating. When the magnet winding is not turned on, the magnet winding does not generate a magnetic force. Preferably, each magnet winding winds around a forward magnetic material such as iron (Fe), cobalt (Co) or nickel (Ni) so as to obtain a better magnetic force. The magnetic element 120 is a permanent magnet or a permanent magnetite. When the magnet winding generates a magnetic force, the magnetic force functions on the magnetic element 120 so that the magnet winding and the magnetic element 120 are attracted together.

The eye module 100 further includes a fixing base 140 for carrying the magnet windings. The above forward magnetic material can be embedded in the fixing base 140. The fixing base 140 can be made from plastics, metal or any material does not affect the magnetic force of the magnet winding.

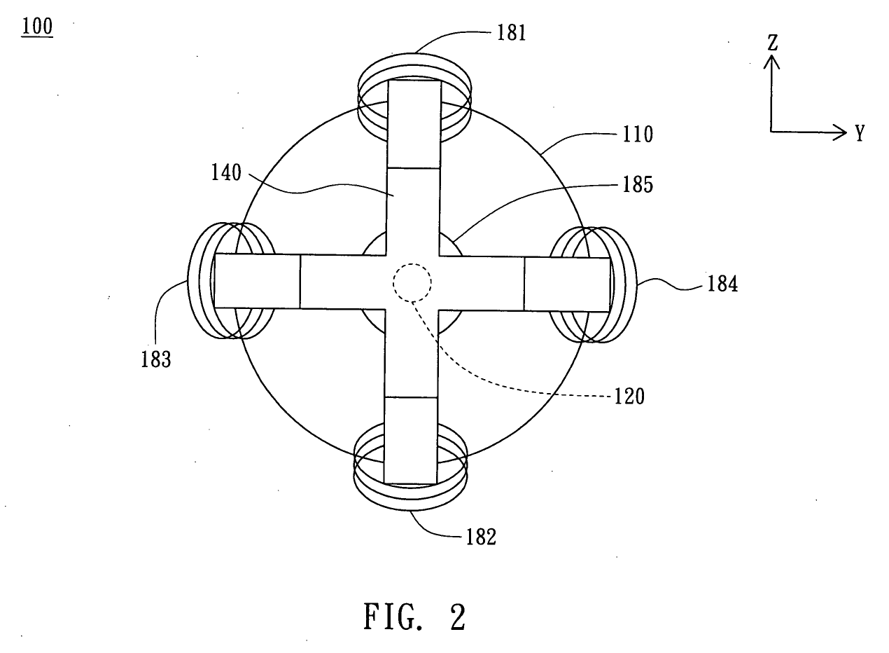

Referring to FIG. 2, a perspective of the magnet windings 181, 182, 183, 184, and 185 and the fixing base 140 of FIG. 1 is shown. The magnet windings are fixed on fixed positions of the fixing base 140. In the present embodiment of the invention, the magnet windings comprise five magnet windings 181, 182, 183, 184, and 185 (FIG. 1 only illustrates the magnet windings 181, 182, and 185). The magnet winding 181, the magnet winding 182, the magnet winding 183, and the magnet winding 184 are respectively disposed on four ends of the fixing base 140. The four ends respectively correspond to the back top, the back bottom, the back right and the back left of the body 110, and the magnet winding 185 is disposed right at the back of the body 110.

As indicated in FIG. 1, the body 110 has a central axis L110. The magnetic element 120 is located on the central axis L110, and the magnet winding 185 is located on the central axis to correspond to the magnetic element 120. When the magnet winding 185 generates a magnetic force, the magnetic force functions on the magnetic element 120, so that the magnet winding 185 and the magnetic element 120 are attracted together. No matter which position the body 110 is rotated to, the body 110 still can return to the central position through the function of the magnet winding 185. Meanwhile, the eye module 110 faces straight.

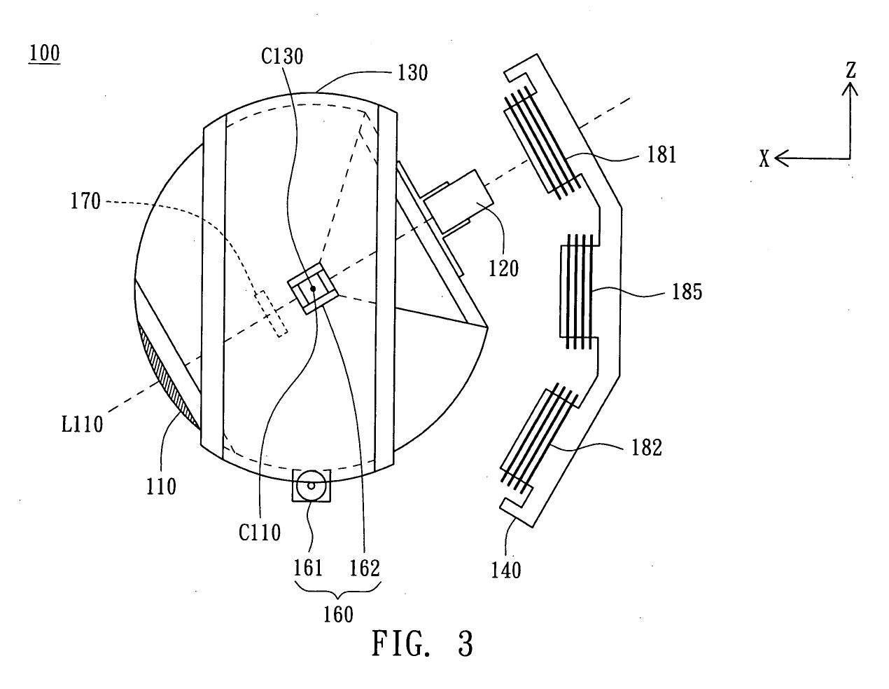

Referring to FIG. 3, a perspective of the body 110 of FIG. 1 rotating downward is shown. When only the magnet winding 181 is turned on and generates a magnetic force, the magnetic force functions on the magnetic element 120 so that the magnet winding 181 and the magnetic element 120 are attracted together. The body 110 is driven by the magnetic element 120 and rotates downward in the casing 130. No matter which location the body 110 was originally positioned at, through the attraction between the magnet winding 181 and the magnetic element 120, the body 110 is rotated downward immediately. Meanwhile, the eye module 100 faces downward.

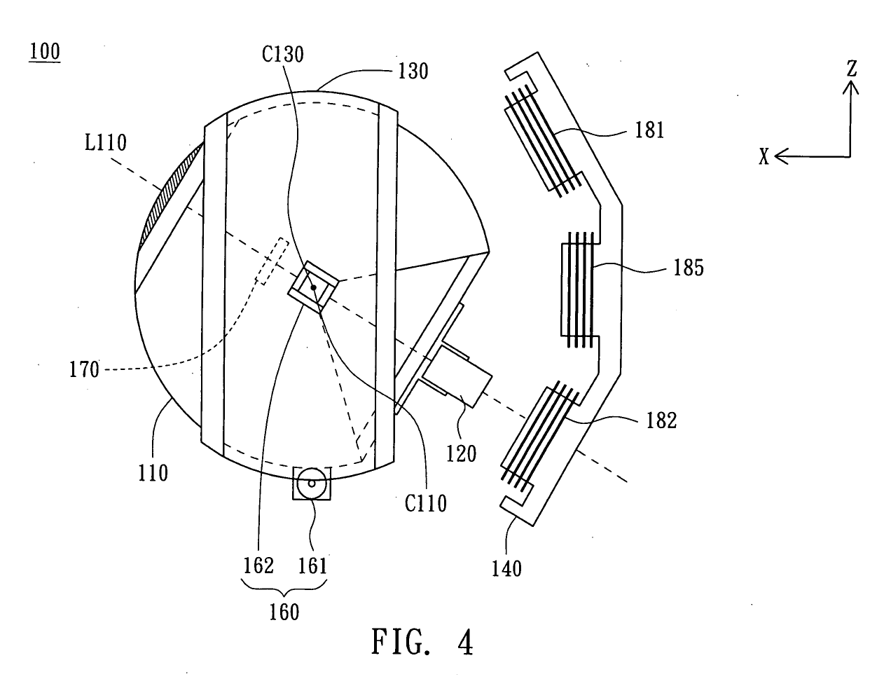

Referring to FIG. 4, a perspective of the body 110 of FIG. 1 rotating upward is shown. When only the magnet winding 182 is turned on and generates a magnetic force, the magnetic force functions on the magnetic element 120 so that the magnet winding 182 and the magnetic element 120 are attracted together. The body 110 is driven by the magnetic element 120 and rotates downward in the casing 130. No matter which location the body 110 was originally positioned at, through the attraction between the magnet winding 182 and the magnetic element 120, the body 110 is rotated downward immediately. Meanwhile, the eye module 100 faces upward.

Besides, the magnet winding 183 and the magnet winding 184 can also be turned on and generates a magnetic force to function on the magnetic element 120 so that the body 110 is driven by the magnetic element and rotate to the left or to the right in the casing 130.

Referring to FIG. 1, FIG. 3 or FIG. 4. The body 110 has a central point C110, and the casing 130 has a casing central point C130. As the inner surface of the casing 130 is substantially similar to the surface of the body 110, the central point C110 and the casing central point C130 are coincide when the body 110 rotates in the casing 130. That is, the body 110 rotates around the central point C110 and will not be deflected.

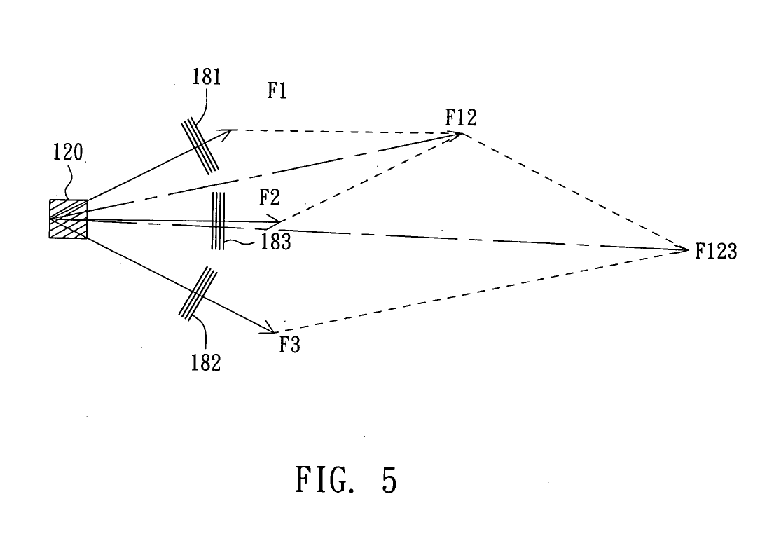

Referring to FIG. 5, a perspective of a join force when three sets of magnet winding 181, 182, 183 are functioning at the same time is shown. In the above exemplifications, a single magnet winding generates a magnetic force. However, the magnet windings each generates a magnetic force which functions on the magnetic element 120 to rotate the body 110 in the direction of the join force. Let FIG. 5 be taken for example, the magnet winding 181, the magnet winding 182 and the magnet winding 183 are turned on to generate a magnetic force respectively, and the forces F1, F2 and F3 function on the magnetic element 120. The force F1 and the force F2 form a join force F12, which in turn forms a join force F123 with the force F3. The magnetic element 120 rotates the body 110 in the direction of the join force F123.

The force generated by each magnet winding with respect to the magnetic element 120 can be easily controlled. According to the theory of electromagnetism, the magnitude of the current flowing to the magnet winding is proportional to the magnitude of the magnetic force. When the direction of the current changes, the direction of the magnetic force also changes accordingly. Thus, the eye module 110 generates a force with particular magnitude and direction on the magnetic element 120 by controlling the magnitude and direction of respective magnet windings. Moreover, a join force is formed by respective forces for rotating the body 110 in the direction of the join force.

In FIG. 5, the magnet windings 181, 182 and 183 respectively generate the forces F1, F2 and F3 on the magnetic element 120. However, the eye module 100 can drive one, two, three, four or five magnet windings and respectively generate individual forces which form a join force so as to function on the magnetic element 120.

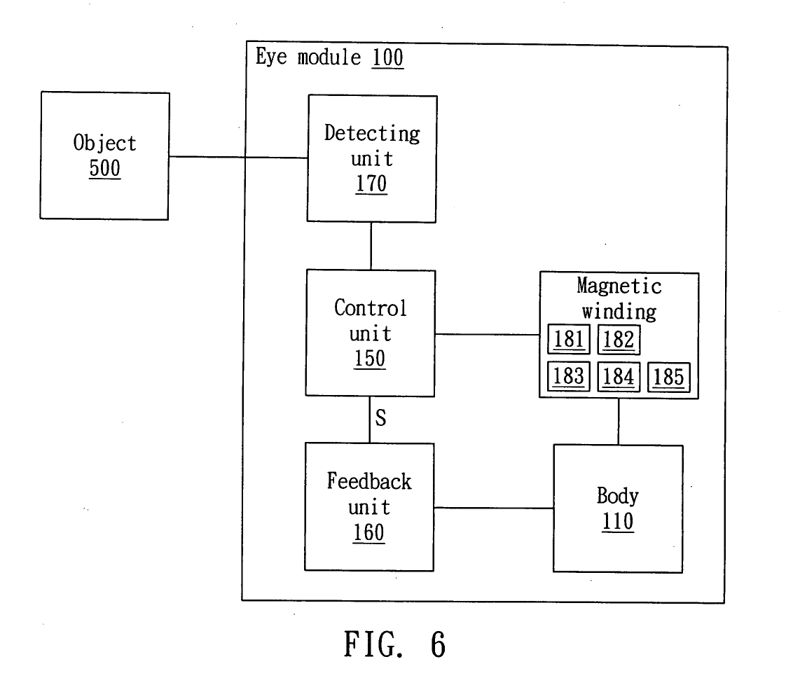

Referring to FIG. 6, a block diagram of the eye module 100 of FIG. 1 is shown. The eye module 100 further includes a control unit 150 electrically connected to the magnet windings 181, 182, 183, 184, and 185 for respectively controlling the currents of the magnet windings 181, 182, 183, 184, and 185 so as the control the conduction, the magnitudes and the directions of the magnetic forces of the magnet windings 181, 182, 183, 184, and 185.

Referring to FIG. 6 and FIG. 1, the eye module 100 further includes a feedback unit 160 for sensing an actual rotation angle of the body 110 to generate an actual angle signal S. The control unit 150 adjusts the currents of the magnet windings 181, 182, 183, 184, and 185 according to actual angle signal S. In the present embodiment of the invention, the feedback unit 160 includes a first feedback 161 and a second feedback 162. The first feedback 161 and the second feedback 162 are disposed at different positions on the surface of the body 110. The first feedback 161 and the second feedback 162 respectively sense the shifts at different directions for calculating the actual rotation angle of the body 110.

As indicated in FIG. 1, the first feedback 161 and the second feedback 162 are roller type feedbacks. Let the first feedback 161 be taken for example. The roller of the first feedback 161 contacts the surface of the body 110. When the body 110 rotates, the roller rolls along with the surface of the body 110. The first feedback 161 obtains the shift of the body 110 according to the number of rolling made by the roller. Similarly, the second feedback 162 is operated in the same manner.

Referring to FIG. 6 and FIG. 1, the eye module 100 further includes a detecting unit 170 for detecting the shift of an object 500. The control unit 150 controls the magnet windings 181, 182, 183, 184, and 185 according to the shift of the object 500. The detecting unit 170 is a charge-coupled device (CCD) or a complementary metal oxide semiconductor (CMOS) sensor. In the present embodiment of the invention, the detecting unit 170 is disposed in the body 110 and has a sensing face directed outward. After the image of the object 500 is projected into the body 110, the detecting unit 170 receives the image of the object 500 for determining the shift of the object 500.

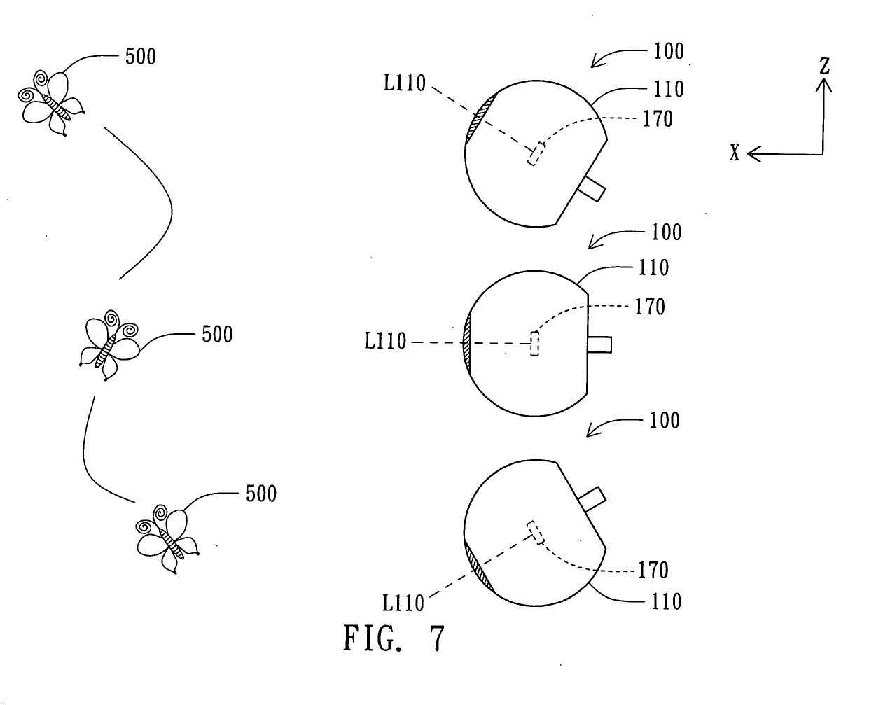

Referring to FIG. 6 and FIG. 7. FIG. 7 is a perspective of the eye module 100 of FIG. 1 following an object 500. When the object 500 moves upward, the detecting unit 170 immediately receives and transmits the image of the object 500 to the control unit 150 (the control unit 150 is illustrated in FIG. 6). The control unit 150, according to the shift of the object 500, controls the magnet windings and rotates the body 110 upward. To the contrary, when the object moves downward, the body 110 rotates downward along with the object 500. Thus, the eye module 100 is able to look at the user engaged in conversation or look at a dynamic article, so that the eye module 100 can function in an interactive manner.

The eye module 100 of the invention does not have complicated gear elements, so the internal cavity of the body 110 can accommodate many electronic elements such as the detecting unit 170 for example. When incorporated with electronic elements, the eye module of the invention is further advantaged by various functions.

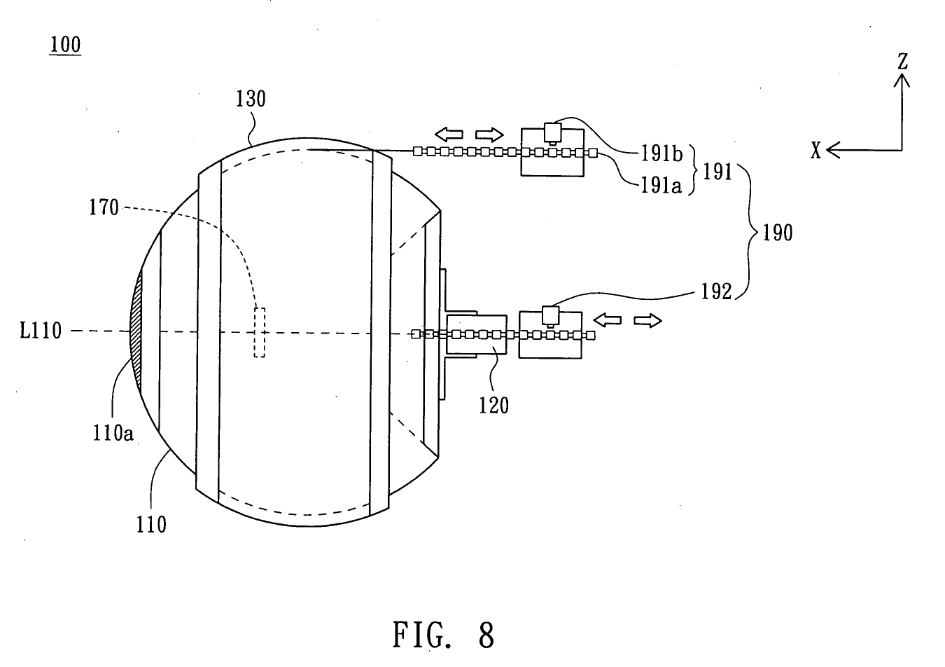

As indicated in FIG. 1, despite the first feedback 161 and the second feedback 162 are exemplified by roller type feedbacks in the present embodiment of the invention, the first feedback 161 and the second feedback 162 of the invention can also be photo-sensing type feedbacks. Referring to FIG. 8, a perspective of the eye module of FIG. 1 using a feedback is shown. In FIG. 8, the feedback unit 190 includes a first feedback 191 and a second feedback 192. Let the first feedback 191 be taken for example. The first feedback 191 includes a moving ruler 191a and a photo-sensor 191b. The moving ruler 191a has a plurality of holes. The photo-sensor 191b emits a light on the moving ruler 191a. The light can pass through the holes if the photo-sensor 191b exactly corresponds to the holes of the moving ruler 191a; otherwise the light is reflected back to the photo-sensor 191b via the surface of the moving ruler 191a. Therefore, when the moving ruler 191a moves, the photo-sensor 191b senses the reflected light with alternation of light and darkness. The first feedback 191 obtains the shift of the body 110 according to the reflected light. Similarly, the second feedback 192 is operated in the same manner.

### Second Embodiment

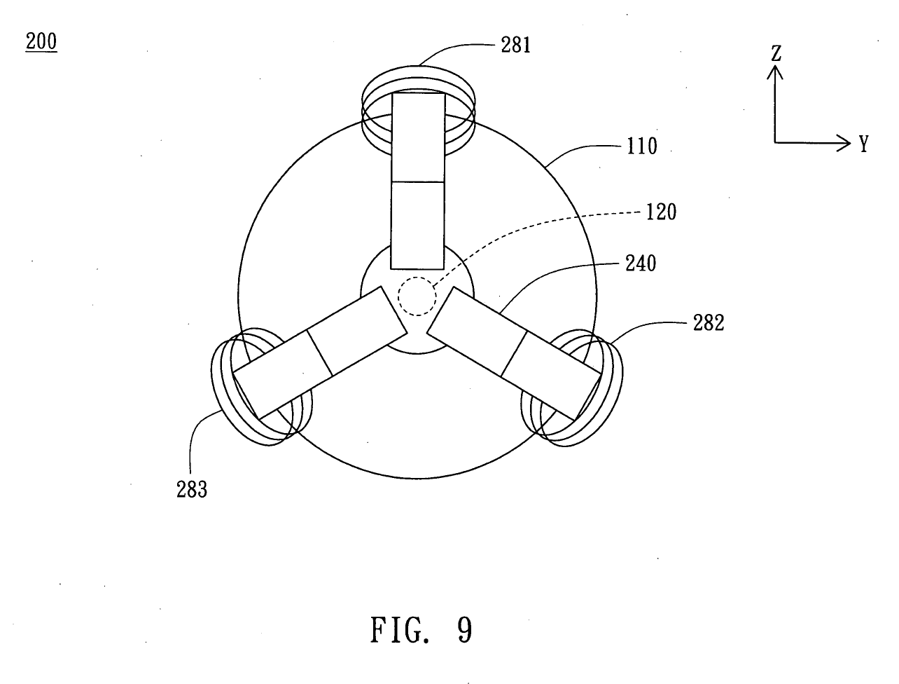

The eye module 200 of the present embodiment of the invention differs with the eye module 100 of the first embodiment in the number and position of the magnet windings, and other similarities are not repeated. Referring to FIG. 9, a perspective of the magnet winding and the fixing element of an eye module 200 according to a second embodiment of the invention is shown. In the present embodiment of the invention, the eye module 200 includes three magnet windings 281, 282, and 283 are respectively disposed on three ends of the fixing base 240. Preferably, the three ends are arranged in a regular triangle.

When the three magnet windings 281, 282, and 283 generate equivalent force which functions on the magnetic element 120, the join force formed by the three forces is directed towards the central axis of the body 110 (the central axis is not illustrated in FIG. 9) for fixing the body 110 at the central position. Meanwhile, the eye module 200 faces the front.

Moreover, the three magnet windings 281, 282, and 283 can generate non-equivalent forces with respect to the magnetic element 120 (the magnetic element 120 is denoted in dotted lines), and the join force formed by the three forces rotates the body 110 to a particular position. Different join forces can be formed according to the magnitudes of the three forces for rotating the body 110 to every particular position.

In the present embodiment of the invention, the eye module 200 can rotate the body 110 toward any direction by three magnet windings 281, 282, and 283, hence having the advantage of low cost and versatile direction of rotation.

### Third Embodiment

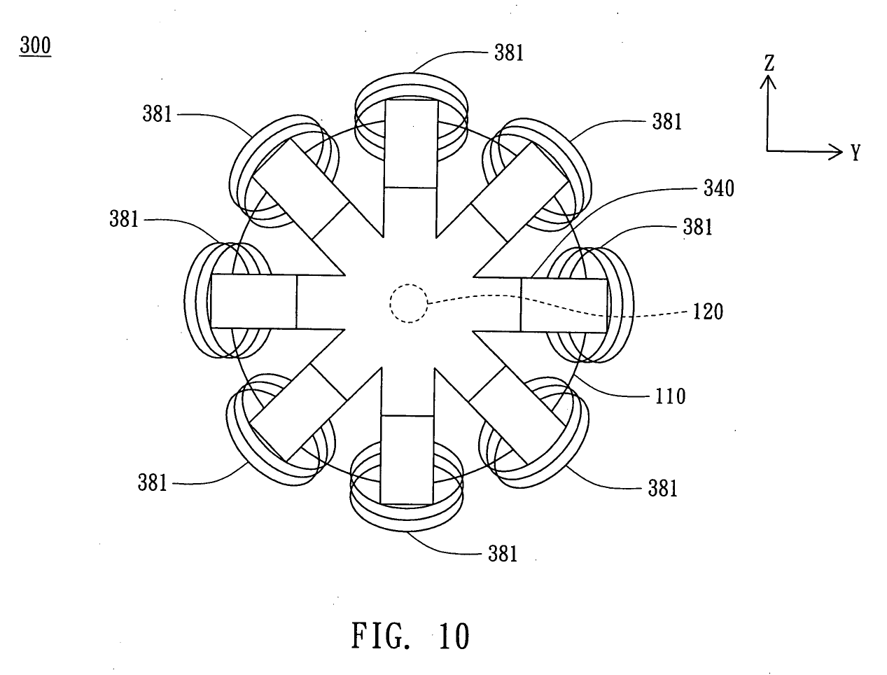

The eye module 300 of the present embodiment of the invention differs with the eye module 100 of the first embodiment in the number and position of the magnet winding 381, and other similarities are not repeated. Referring to FIG. 10, a perspective of the magnet winding 381 and the fixing element 340 of an eye module according to a third embodiment of the invention is shown. In the present embodiment of the invention, a plurality of magnet windings 381 surround the magnetic element 120 and are disposed on the fixing base 240 (the magnetic element 120 is denoted by dotted lines). Preferably, the magnet windings 381 are symmetrically arranged and surround the magnetic element 120. Similarly, the magnet windings 381 can generate respective forces on the magnetic element 120 individually or concurrently. The number and arrangement of the magnet windings 381 of the eye module 300 are designed according to the needs of the product.

### Fourth Embodiment

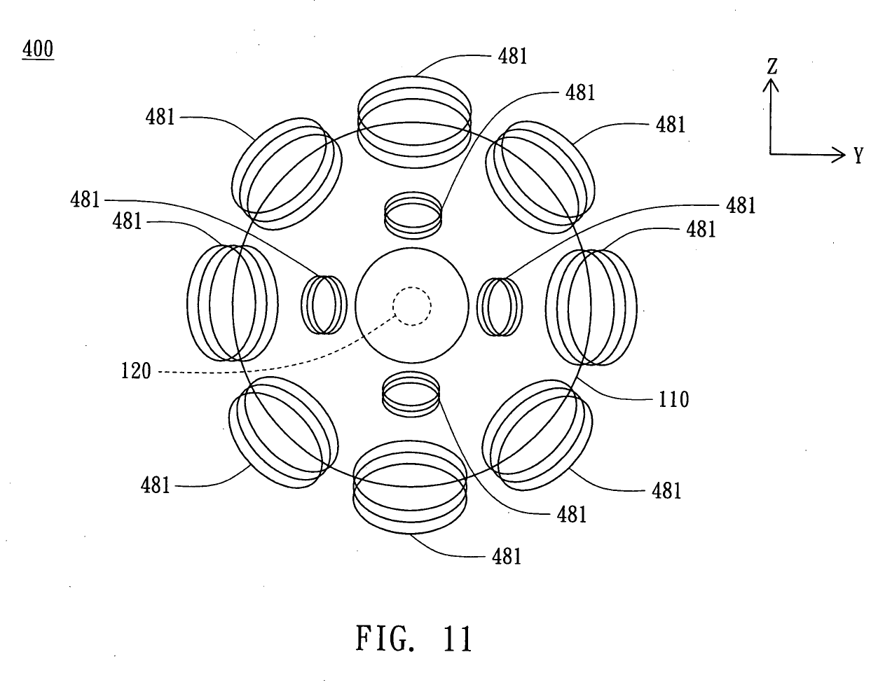

The eye module 400 of the present embodiment of the invention differs with the eye module 100 of the first embodiment in the number and position of the magnet winding 481, and other similarities are not repeated. Referring to FIG. 11, a perspective of a magnet winding 481 according to a fourth embodiment of the invention. In the present embodiment of the invention, a plurality of magnet windings 481 are arranged in a matrix and disposed on the fixing base. In FIG. 11, the fixing base is a bowl structure for carrying the magnet windings 481 (the fixing base is not illustrated in FIG. 11). Preferably, the magnet windings 481 are symmetrically arranged in a matrix. As disclosed above, the magnet windings 481 can generate respective forces on the magnetic element 120 individually or concurrently. The number and arrangement of the magnet windings 481 of the eye module 400 are designed according to the needs of the product.

Generally speaking, the lesser the number of the magnet windings 481 is, the lower the material cost of the eye module 400 will be. On the other hand, the larger the number of the magnet windings 481 is, the easier the control of the eye module 400 will be.

The eye module disclosed in the above embodiments of the invention uses a plurality of magnet windings to generate respective forces on a magnetic element for rotating the body, not only enabling the eye module of the invention to rotate but also possess the following advantages.

Firstly, the eye module of the invention has small size and light weight. the eye module of the invention achieves the objects of the invention by a plurality of magnet windings and a magnetic element without using gear sets and rods, largely reducing the size and weight of the eye module, hence conforming to the current trend of lightweight, thinness, shortness and compactness.

Secondly, the eye module of the invention has fast and prompt response. When a current flows through the magnet winding, the magnet winding immediately generates a force on the magnetic element and drives the body to rotate. All movements are done almost simultaneously and at once, hence having prompt and fast response.

Thirdly, the eye module of the invention has all-directional rotation. The forces generated by the magnet windings with respect to the magnetic element form a join force. The eye module can adjust the direction of the join force by adjusting the magnitude of the currents of the magnet windings. As the join force is not limited to any particular direction, the body can rotate toward any direction according to the join force.

Fourthly, the eye module of the invention accommodates more elements. As the eye module of the invention does not require complicated gear elements, the internal cavity of the body can accommodate more electronic elements. In the above embodiments, the detecting unit is disposed inside the body. As the internal cavity of the body can accommodate more electronic elements such as LED light, micro-camera or figure recognition module, the eye module of the invention possess more functions.

Fifthly, the eye module of the invention has precise feedback control. The eye module of the invention is installed with a feedback unit which feedbacks an actual rotation angle to the body. During the process of rotating the body, the control unit can precisely adjust the body to an accurate rotation angle, largely improving the precision and accuracy in operating the eye module.

Sixthly, the eye module of the invention has interactive mode. The eye module of the invention is further installed with a detecting unit for detecting the shift of an object so that the eye module can look at the user engaged in conversation or at a dynamic object.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An eye module, at least comprising:
a body in the shape of a globe;
a magnetic element disposed on the body;
a casing, wherein the body is disposed in the casing in a rotatable manner; and
a plurality of magnet windings disposed at the back of the body;
wherein the body is rotated by driving the magnet windings to function on the magnetic element.

2. The eye module according to claim 1, further comprising:
a fixing base for carrying the magnet windings.

3. The eye module according to claim 2, wherein the magnet windings surround the magnetic element and are disposed on the fixing base.

4. The eye module according to claim 2, wherein the magnet windings comprise:
three magnet windings respectively disposed on three ends of the fixing base.

5. The eye module according to claim 2, wherein the magnet windings comprise:
four magnet windings respectively disposed on four ends of the fixing base.

6. The eye module according to claim 5, wherein the ends are respectively disposed at the back top, the back bottom, the back right and the back left of the body.

7. The eye module according to claim 1, wherein the magnet windings are disposed on the fixing base and arranged in a matrix.

8. The eye module according to claim 1, wherein the body has a central axis on which the magnetic element is located.

9. The eye module according to claim 1, wherein the body has a central axis on which the magnetic element is located, one of the magnet windings is located on the central axis to correspond to the magnetic element for positioning the body.

10. The eye module according to claim 1, the body has a central point, the casing comprises a casing central point, when the body is rotated in the casing, and the central point and the casing central point are coincided.

11. The eye module according to claim 1, further comprising:
a control unit electrically connected to the magnet windings, wherein the control unit respectively controls the current of the magnet windings for controlling the conduction, the magnitudes and the directions of a magnetic force of the magnet windings.

12. The eye module according to claim 11, further comprising:
a feedback unit for sensing an actual rotation angle of the body to generate an actual angle signal;
wherein the control unit adjusts the current of the magnet windings according to the actual angle signal.

13. The eye module according to claim 11, further comprising:
a detecting unit for detecting the shift of an article;
wherein the control unit controls the magnet windings according to the shift of the article.

14. The eye module according to claim 1, wherein the magnetic element is a permanent magnet or a permanent magnetite.

15. The eye module according to claim 1, wherein each magnet windings generates a force which functions on the magnetic element for rotating the body in the direction of the join forces.
